(19) United States
(12) Patent Application Publication
(10) Pub. No.: US 2025/0108780 A1
(43) Pub. Date: Apr. 3, 2025

(54) Stabilizing Apparatus for a Recreational Vehicle

(71) Applicant: Darius Goodall, San Jose, CA (US)

(72) Inventor: Darius Goodall, San Jose, CA (US)

(21) Appl. No.: 18/477,923

(22) Filed: Sep. 29, 2023

(51) Int. Cl. B60S 9/08

(52) U.S. Cl. CPC B60S 9/08

(57) ABSTRACT

A support assembly to stabilize a vehicle has a cylinder with a shaft extendable downward, a foot element comprising a foot plate and a dome, a bolt secured into a lower end of the shaft through a spacer tube, two washers separated vertically by an o-ring, and an articulation plate having a ring groove matching an end shape of the shaft, a lower surface having the shape of a portion of a sphere of the outside surface of the dome, and a central hole of a diameter substantially greater than the diameter of the spacer tube, the articulation plate resting on the dome of the foot element. With the shaft partially extended the foot element is loosely carried, with the shaft fully extended the assembly carries weight of the vehicle, and with the shaft fully retracted the foot element is rigidly secured.

### BACKGROUND OF THE INVENTION

### 1. Field of the Invention

The present invention is in the technical field of automotive and vehicular equipment and pertains more particularly to an extendable cylinder shaft with an articulating foot to support weight of and stabilize a vehicle.

### 2. Description of Related Art

It is well known in the art that many recreational vehicles (RVs) are equipped with cylinders, either pneumatic or hydraulic, often placed in corner locations, that extend shafts with feet at a lower end, such that the extended shafts urge the feet onto the ground surface to stabilize the RV while stationary so activity of persons in the RV will not deflect the suspension system and cause instability in use. By ground surface in this specification is meant the surface upon which the RV may park, whether dirt, lawn, pavement, cinders, are other surface. It is also well known that in the conventional art the feet are rigidly fixed to the shafts and are often of a structure that is insufficient to always support the weight of the vehicle without damage to the support system and/or the feet. A particular problem is that RV parks in various locales do not always have rigid and level surfaces for parking an RV, and when a cylinder shaft with a foot is extended, the foot may not contact the ground surface evenly, but may contact on an edge of the foot, causing lateral force on the extended shaft and excessive forces on parts of the foot.

What is clearly needed is a more rugged foot attached to a lower end of the cylinder shaft in a manner that the foot may articulate to an extent sufficient to allow the foot to contact the ground surface evenly.

### BRIEF SUMMARY OF THE INVENTION

In one embodiment of the invention a support assembly to stabilize a vehicle is provided, comprising a cylinder fastened to a frame member of the vehicle, the cylinder having a shaft extendable vertically downward, a foot element comprising a foot plate with a centrally welded dome having a shape of a portion of a sphere, a bolt rigidly secured into a lower end of the shaft through a spacer tube having a first length, two washers separated vertically by an o-ring, a lower of the two washers resting on a head of the bolt, and an articulation plate having an upper surface with a ring groove matching an end shape of the shaft, a lower surface having the shape of a portion of a sphere of the outside surface of the dome, a central hole of a diameter substantially greater than the diameter of the spacer tube, the articulation plate resting on the dome of the foot element. The support assembly is characterized in that with the shaft partially extended the foot element is loosely carried by an outside edge of the upper of the two washers in contact with an inside surface of the dome of the foot element, the shaft not in contact with the articulation plate, in that with the shaft fully extended and the foot element forced against a ground surface, carrying a portion of weight of the vehicle, the lower end of the shaft engages the ring groove of the articulation plate transferring the portion of the weight to the articulation plate which transfers the portion of the weight to the dome which transfers the portion of the weight to the ground surface through the ground plate, and in that with the shaft fully retracted, the articulation plate is drawn into contact with a stationary portion of the cylinder, the shaft retracts further compressing the o-ring between the two washers, securing the foot element rigidly against the articulation plate.

In one embodiment the support assembly further comprises two or more additional cylinders fastened to frame members of the vehicle, wherein the three or more cylinders with shafts fully extended urge the three of more foot elements against the ground surface and carry the full weight of the vehicle not supported by wheels of the vehicle through a suspension system of the vehicle. Also, in one embodiment the three or more cylinders with shafts fully retracted secure the three or more foot elements rigidly against the three or more cylinders with the o-rings partially compressed. In one embodiment, as the shaft is extended and the foot plate contacts the ground surface, the foot element rotates with the dome against the articulation plate until the foot plate assumes the angle from horizontal of the ground surface, then the shaft engages the groove of the articulation plate. And in one embodiment the support assembly further comprises two or more additional cylinders fastened to frame members of the vehicle, wherein the foot elements carried by shafts of the three or more cylinders assume the angle from horizontal of the ground surface at the different points where each of the three or more foot elements contact the ground surface.

In one embodiment the articulation plate is steel heat treated for hardness. Also in one embodiment the foot plate has an opening under the dome of a diameter less than the inside diameter of the dome, affording access to elements under the dome in assembly and service. Also, in one embodiment the cylinder is a hydraulic cylinder. And in one embodiment the cylinder is a pneumatic cylinder.

In another aspect of the invention a method for stabilizing a stationary vehicle is provided, comprising fastening three or more support assemblies to frame members of the vehicle, the support assemblies each having a cylinder with a shaft extendable vertically downward, a foot element comprising a foot plate with a centrally welded dome having a shape of a portion of a sphere, a bolt rigidly secured into a lower end of the shaft through a spacer tube having a first length, two washers separated vertically by an o-ring, a lower of the two washers resting on a head of the bolt, and an articulation plate having an upper surface with a ring groove matching an end shape of the shaft, a lower surface having the shape of a portion of a sphere of the outside surface of the dome, a central hole of a diameter substantially greater than the diameter of the spacer tube, the articulation plate resting on the dome of the foot element, carrying the foot element loosely with the shaft partially extended, supported on an outer edge of an upper of the two washers in contact with an inside surface of the dome of the foot element, the shaft not in contact with the articulation plate, carrying a portion of a weight of the vehicle with the shaft fully extended and the foot element forced against a ground surface, the lower end of the shaft engaging the ring groove of the articulation plate transferring the portion of the weight to the articulation plate which transfers the portion of the weight to the dome which transfers the portion of the weight to the ground surface through the ground plate, and securing the foot element against the cylinder with the shaft fully retracted, drawing the articulation plate into contact with a stationary portion of the cylinder, retracting the shaft further, compressing the o-ring between the two washers, securing the foot element rigidly against the articulation plate.

In one embodiment the method comprises deploying two or more additional cylinders fastened to frame members of the vehicle, fully extending the shafts of the three or more cylinders urging the three of more foot elements against the ground surface and carrying the full weight of the vehicle not supported by wheels of the vehicle through a suspension system of the vehicle. Also, in one embodiment the method comprises fully retracting the shafts of the three or more cylinders, securing the three or more foot elements rigidly against the three or more cylinders with the o-rings partially compressed. In one embodiment the method comprises, as the shaft is extended and the foot plate contacts the ground surface, rotating the foot element with the dome against the articulation plate until the foot plate assumes the angle from horizontal of the ground surface, then engaging the groove of the articulation plate with the shaft. In one embodiment the method comprises deploying two or more additional cylinders fastened to frame members of the vehicle, wherein the foot elements carried by shafts of the three or more cylinders assume the angle from horizontal of the ground surface at the different points where each of the three or more foot elements contact the ground surface.

In one embodiment the method comprises heat treating the articulation plate for hardness. In one embodiment the method comprises providing an opening in the foot plate under the dome of a diameter less than the inside diameter of the dome, affording access to elements under the dome in assembly and service. In one embodiment the method comprises providing the cylinder as a hydraulic cylinder. And in one embodiment the method comprises providing the cylinder as a pneumatic cylinder.

### BRIEF DESCRIPTION OF THE SEVERAL VIEWS OF THE DRAWINGS

FIG. 1A is a prior art illustration of an RV and a set of four cylinders extended with feet contacting a ground surface.

FIG. 1B is a prior art side elevation view of the RV and cylinders of FIG. 1A.

FIG. 2 is an illustration of a cylinder with extended shaft and foot contacting a ground surface in the prior art.

FIG. 3 is a side elevation view of an extended shaft with an articulating foot in an embodiment of the present invention.

FIG. 4 is a cross-section assembly view of the extended shaft with an articulating foot of FIG. 3 with additional elements illustrating relationships of elements of the assembly.

FIG. 5 is a side elevation cross-section of the assembly of FIG. 4 with the shaft fully extended urging the foot against an even ground surface at a right angle to the shaft.

FIG. 6 is a side elevation cross-section of the assembly of FIG. 4 with the shaft fully extended urging the foot against an uneven ground surface.

FIG. 7 is a cross-section view of the assembly of FIG. 4 with the shaft of the cylinder fully retracted.

### DETAILED DESCRIPTION OF THE INVENTION

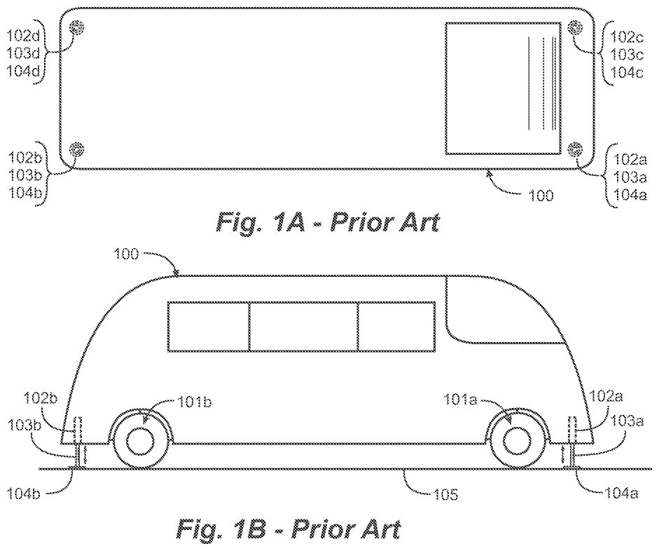

FIG. 1A is a prior art plan view of an RV 100 and a set of four cylinders 102a-102d with cylinder shafts 103a-103d extended with feet 104a-104d contacting a ground surface 105. FIG. 1B is a prior art side elevation view of RV 100 and the cylinders, shafts and feet of FIG. 1A.

It may be seen that in this example a cylinder with an extendable shaft and a foot is implemented near each of four corners of the plan view footprint of RV 100. In alternative circumstances three sets of support cylinders might be sufficient but four is considered a better arrangement. FIG. 1B particularly shows shafts extended with feet contacting the ground surface. Typically, the shafts are extended to a degree to lift the RV against the suspension of the wheels of the RV but not enough to raise any one of the wheels off of the ground surface. With the cylinder shafts extended it is the contact of the tires of the wheels that prevents sideways motion of the RV which will put lateral stress on the cylinders. The exact placement of the cylinders may depend on the make and model of the RV, and at is only required that the four cylinders and assemblies form a stable support system for the RV.

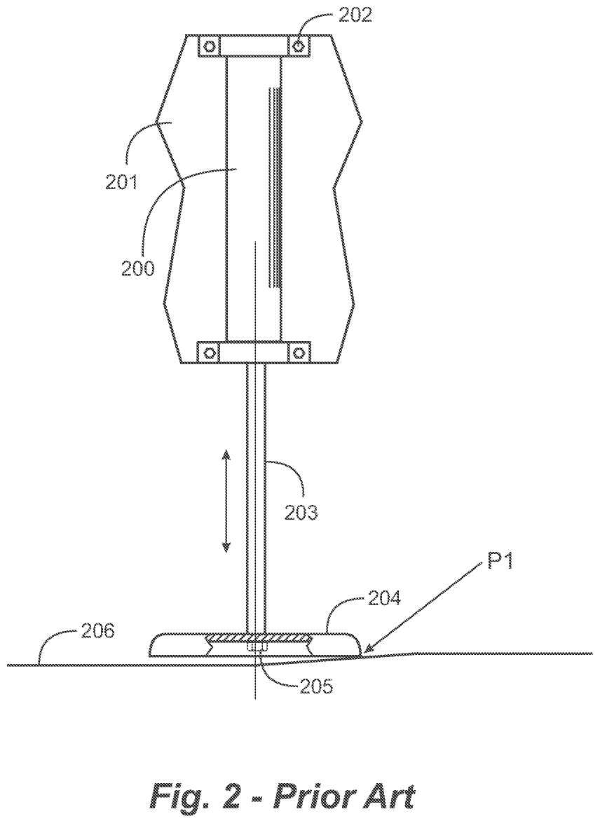

FIG. 2 is an illustration of a cylinder 200 bolted to a frame member 201 of an RV by bolts 202, with shaft 203 fully extended and foot 204 rigidly fastened to shaft 203 by a bolt 205, contacting an uneven ground surface 206 in the prior art. The cylinder, shaft and foot in FIG. 2 may be any one of the four illustrated in FIG. 1.

It may be seen that in the circumstance of FIG. 2 foot 204 will not contact surface 206 evenly, but at first only at point P1. This is a common circumstance in the prior art, and the result is twisting of foot 204 relative to shaft 203 at the point of fastening with bolt 205, and lateral force on shaft 203 and cylinder 200. The forces created in this situation may damage the elements of the assembly and may result in unnecessary wear and early failure of the assembly.

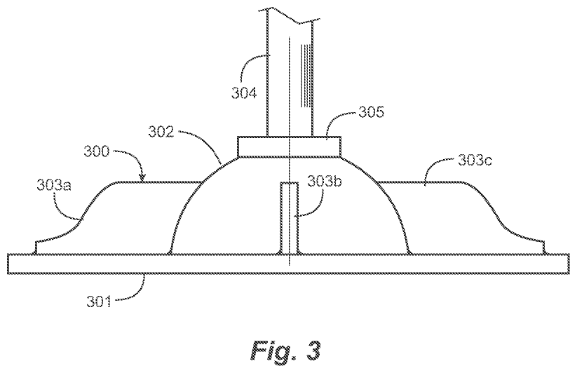

FIG. 3 is a side elevation view of a foot 300 fastened to a cylinder shaft 304 in an embodiment of the present invention. Foot 300 is a welded assembly in this example comprising a foot plate 301, a dome 302 welded centrally to plate 301, and four reinforcing gussets of which three, gussets 303a, 303b and 303c, may be seen. In other embodiments there may be more or fewer gussets, or none at all. The foot plate may be a circular plate with a central hole of a diameter just less than the inside diameter of a bottom of dome 302. This large hole affords access to elements under the dome in assembly and service. The gussets are welded to both dome 302 and to foot plate 301 and serve as reinforcing elements to the assembly. An articulation plate 305 is fastened rigidly to shaft 304 by a bolt (not seen in FIG. 3). Foot 302, when not in contact with a ground surface or fully withdrawn, is loosely carried and may articulate in a limited range. The specific assembly that enables articulation is described in enabling detail below with aid of cross-section drawings. The articulation plate in some circumstances is heat treated for hardness. The dome in some embodiments may be carbon steel and may also be hardened. In some embodiments the dome and the articulation plate may also be machined to provide suitable mating surfaces.

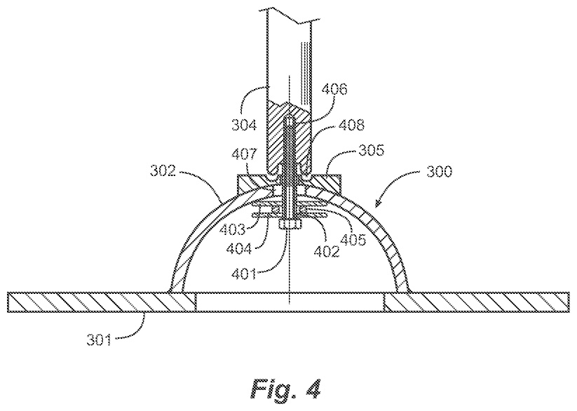

FIG. 4 is a cross-section assembly view of the extended shaft with an articulating foot of FIG. 3 with additional elements illustrating relationships of elements of the assembly. The assembly is shown in this view in a circumstance with cylinder shaft 304 partially withdrawn (or partially extended). In this circumstance foot 300 is suspended beneath shaft 304 by a bolt 401 fully engaged in a threaded hole 406 along a longitudinal axis of the shaft from below. Bolt 401 passes through a spacer tube 402 of a certain length and is drawn up tight against the tube. The length of the spacer tube causes bolt 401 to extend a substantial length below a lower end of shaft 304. Articulation plate 305 has a center hole just larger than the outside diameter of the spacer tube and rests on a top spherical surface of dome 302 of foot 300. An underside of the articulation plate has the same spherical surface as the outer surface of the dome, and an upper surface of articulation plate 305 has a circular groove 408 that conforms in shape to the lower end of shaft 304. In this circumstance foot 300 is carried suspended on an assembly of two washers, washer 403 and washer 404, separated by an o-ring 405, and held by the head of bolt 401. Bolt 401 and spacer tube 402 pass through a hole 407 in the top of dome 302 of foot 300. Hole 407 has a substantially greater diameter than the outside diameter of spacer tube 402.

It should be apparent to the skilled person, having followed the description of the cross-section view of FIG. 4, that foot 300, with shaft 304 partially extended or retracted, is loosely held, and may move articulate from the level position shown, limited by the diameter of hole 407 in the top of dome 302.

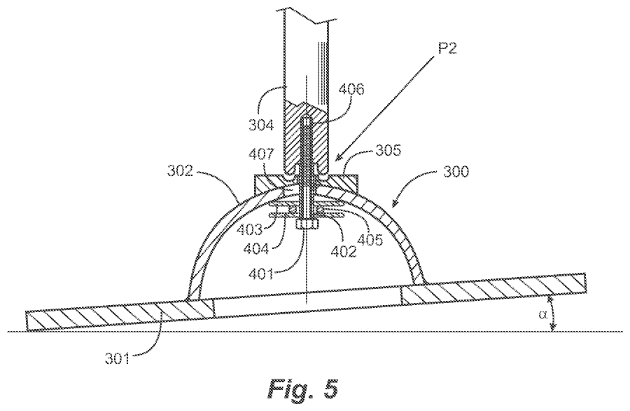

FIG. 5 shows the assembly in cross-section of FIG. 4 with foot 300 rotated within the limits of hole 407. In this example the rotation of foot 300 relative to the rest of the assembly is an angle α of about 10 degrees to horizontal. It may be seen that an edge of hole 407 in dome 302 of foot 300 is in contact with spacer tube 402. In this circumstance foot 300 is still carried by washers 403, 404 and o-ring 405. It should be noted that in this circumstance there is a vertical space between the lower end of shaft 304 and a socket ring in the top of articulation plate 305 (see point P2).

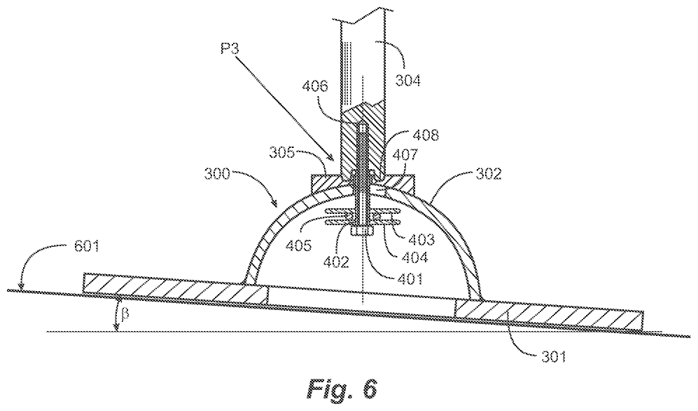

FIG. 6 shows the assembly in cross-section of FIG. 5 with shaft 304 fully extended and foot 300 in contact with a ground surface 601 that is off level by angle β, also about ten degrees but in an opposite direction to angle α of FIG. 5. It may be seen that as plate 301 of foot 300 contacts ground surface 601 the foot adjusts to an articulation of angle β. Also, shaft 304 further extends until the lower end of the shaft engages circular groove 408. In this circumstance a substantial portion of the weight of RV 100 is carried by shaft 304 against articulation plate 305 which rests on dome 302 which transfers the force to plate 301 and hence to ground surface 601. It should be apparent to the skilled person that the articulation of plate 301 hence foot 300 is only limited by the inside diameter of hole 407 in dome 302, and could be greater, if needed, by providing a hole 407 with a larger diameter.

In operation the RV is parked in a preferred location, and shafts 304 of each of (usually) four cylinders are extended. The feet of each assembly contact the ground surface, articulate as needed, and lift the RV against the suspension system, leaving the tires of the wheels on the ground, preventing side motion of the RV. The RV rests on the four feet, and if needed the extension of the shafts may be adjusted to level a floor of the RV.

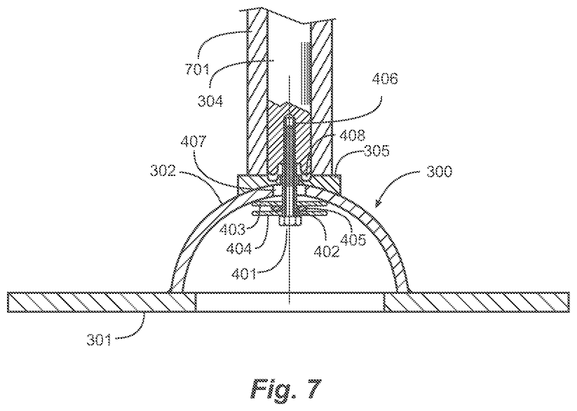

When the RV is again to be driven away the shafts of the cylinders are retracted lowering the weight of the RV fully on its suspension system and raising the feet off the ground surface to a stowed position. FIG. 7 shows one of the cylinders with shaft fully retracted, illustrating the circumstance of each of the shafts retracted. As shaft 304 fully retracts articulation plate 305 contacts cylinder portion 701 and shaft 304 retracts a short distance further compressing o-ring 405 as shown. This action presses dome 300 against articulation plate 305 locking the foot in place in a manner that it will not move and cause vibration as the RV is driven over surfaces and roads. All four cylinders and feet are locked in place by this circumstance. At a new location the RV may be parked and the cylinder shafts extended again as described above.

A skilled artisan will understand that the descriptions above are for embodiments of the invention that are examples and are not limiting to the scope of the invention. There are many alterations that may be made depending, for example, on the RV involved, the characteristics of the cylinders. The design of the feet and other factors, all within the scope of the invention. The scope of the invention is limited only by the claims that follow.

1. A support assembly to stabilize a vehicle, comprising:
a cylinder fastened to a frame member of the vehicle, the cylinder having a shaft extendable vertically downward;
a foot element comprising a foot plate with a centrally welded dome having a shape of a portion of a sphere;
a bolt rigidly secured into a lower end of the shaft through a spacer tube having a first length;
two washers separated vertically by an o-ring, a lower of the two washers resting on a head of the bolt; and
an articulation plate having an upper surface with a ring groove matching an end shape of the shaft, a lower surface having the shape of a portion of a sphere of the outside surface of the dome, a central hole of a diameter substantially greater than the diameter of the spacer tube, the articulation plate resting on the dome of the foot element;
characterized in that with the shaft partially extended the foot element is loosely carried by an outside edge of the upper of the two washers in contact with an inside surface of the dome of the foot element, the shaft not in contact with the articulation plate, in that with the shaft fully extended and the foot element forced against a ground surface, carrying a portion of weight of the vehicle, the lower end of the shaft engages the ring groove of the articulation plate transferring the portion of the weight to the articulation plate which transfers the portion of the weight to the dome which transfers the portion of the weight to the ground surface through the ground plate, and in that with the shaft fully retracted, the articulation plate is drawn into contact with a stationary portion of the cylinder, the shaft retracts further compressing the o-ring between the two washers, securing the foot element rigidly against the articulation plate.

2. The support assembly of claim 1 further comprising two or more additional cylinders fastened to frame members of the vehicle, wherein the three or more cylinders with shafts fully extended urge the three of more foot elements against the ground surface and carry the full weight of the vehicle not supported by wheels of the vehicle through a suspension system of the vehicle.

3. The support assembly of claim 2 wherein the three or more cylinders with shafts fully retracted secure the three or more foot elements rigidly against the three or more cylinders with the o-rings partially compressed.

4. The support assembly of claim 1 wherein, as the shaft is extended and the foot plate contacts the ground surface, the foot element rotates with the dome against the articulation plate until the foot plate assumes the angle from horizontal of the ground surface, then the shaft engages the groove of the articulation plate.

5. The support assembly of claim 4 further comprising two or more additional cylinders fastened to frame members of the vehicle, wherein the foot elements carried by shafts of the three or more cylinders assume the angle from horizontal of the ground surface at the different points where each of the three or more foot elements contact the ground surface.

6. The support assembly of claim 1 wherein the articulation plate is steel heat treated for hardness.

7. The support assembly of claim 1 wherein the foot plate has an opening under the dome of a diameter less than the inside diameter of the dome, affording access to elements under the dome in assembly and service.

8. The support assembly of claim 1 wherein the cylinder is a hydraulic cylinder.

9. The support assembly of claim 1 wherein the cylinder is a pneumatic cylinder.

10. A method for stabilizing a stationary vehicle, comprising:
fastening three or more support assemblies to frame members of the vehicle, the support assemblies each having a cylinder with a shaft extendable vertically downward, a foot element comprising a foot plate with a centrally welded dome having a shape of a portion of a sphere, a bolt rigidly secured into a lower end of the shaft through a spacer tube having a first length, two washers separated vertically by an o-ring, a lower of the two washers resting on a head of the bolt, and an articulation plate having an upper surface with a ring groove matching an end shape of the shaft, a lower surface having the shape of a portion of a sphere of the outside surface of the dome, a central hole of a diameter substantially greater than the diameter of the spacer tube, the articulation plate resting on the dome of the foot element;
carrying the foot element loosely with the shaft partially extended, supported on an outer edge of an upper of the two washers in contact with an inside surface of the dome of the foot element, the shaft not in contact with the articulation plate, carrying a portion of a weight of the vehicle with the shaft fully extended and the foot element forced against a ground surface, the lower end of the shaft engaging the ring groove of the articulation plate transferring the portion of the weight to the articulation plate which transfers the portion of the weight to the dome which transfers the portion of the weight to the ground surface through the ground plate, and securing the foot element against the cylinder with the shaft fully retracted, drawing the articulation plate into contact with a stationary portion of the cylinder, retracting the shaft further, compressing the o-ring between the two washers, securing the foot element rigidly against the articulation plate.

11. The method of claim 10 comprising deploying two or more additional cylinders fastened to frame members of the vehicle, fully extending the shafts of the three or more cylinders urging the three of more foot elements against the ground surface and carrying the full weight of the vehicle not supported by wheels of the vehicle through a suspension system of the vehicle.

12. The method of claim 11 comprising fully retracting the shafts of the three or more cylinders, securing the three or more foot elements rigidly against the three or more cylinders with the o-rings partially compressed.

13. The method of claim 10 wherein, as the shaft is extended and the foot plate contacts the ground surface, rotating the foot element with the dome against the articulation plate until the foot plate assumes the angle from horizontal of the ground surface, then engaging the groove of the articulation plate with the shaft.

14. The method of claim 13 further comprising deploying two or more additional cylinders fastened to frame members of the vehicle, wherein the foot elements carried by shafts of the three or more cylinders assume the angle from horizontal of the ground surface at the different points where each of the three or more foot elements contact the ground surface.

15. The method of claim 10 comprising heat treating the articulation plate for hardness.

16. The method of claim 10 comprising providing an opening in the foot plate under the dome of a diameter less than the inside diameter of the dome, affording access to elements under the dome in assembly and service.

17. The method of claim 10 comprising providing the cylinder as a hydraulic cylinder.

18. The method of claim 10 comprising providing the cylinder as a pneumatic cylinder.
